(19) United States
(12) Patent Application Publication
(10) Pub. No.: US 2026/0341798 A1
(43) Pub. Date: Oct. 29, 2026

(54) POUCH-TYPE BIPOLAR SOLID-STATE BATTERY MODULE

(71) Applicant: GM GLOBAL TECHNOLOGY OPERATIONS LLC, Detroit, MI (US)

(72) Inventors: Zhe LI, Shanghai (CN); Meiyuan WU, Shanghai (CN); Haijing LIU, Shanghai (CN); Dave Gerard RICH, Sterling Heights, MI (US)

(21) Appl. No.: 19/464,870

(22) Filed: Jan. 30, 2026

(30) Foreign Application Priority Data
Apr. 29, 2025 (CN) 202510564888X

(51) Int. Cl. H01M 10/0585; H01M 50/105

(52) U.S. Cl. CPC H01M 10/0585; H01M 50/105

(57) ABSTRACT

A pouch-type battery module includes M parallel-connected battery cell cores each including anode electrodes, cathode electrodes, separators, cathode current collectors, and anode current collectors arranged in a stack and connected in parallel, where M is an integer greater than one. First and second external tabs are connected to the anode current collectors and the cathode current collectors, respectively, of the M parallel-connected battery cell cores. M-1 bipolar laminated films are arranged between adjacent ones of the M parallel-connected battery cell cores. First and second outer laminated films arranged adjacent to outer ones of the M parallel-connected battery cell cores and encapsulating the M parallel-connected battery cell cores with the first and second external tabs connected together and extending from opposite sides thereof. The pouch-type battery module can be a liquid-type, semi-solid-state, or all-solid-state battery.

### CROSS-REFERENCE TO RELATED APPLICATIONS

This application claims the benefit of Chinese Patent Application No. 202510564888.X, filed on April 29, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery systems for vehicles, and more particularly to a pouch-type bipolar solid-state battery module.

Low voltage automotive battery systems such as 12V battery systems can be used for starting vehicles, supporting stop/start functionality, and/or supplying vehicle accessory loads or other vehicle systems. Low voltage automotive battery systems can also be used to support vehicle accessory loads in electric vehicles (EVs) such as battery electric vehicles, hybrid vehicles and/or fuel cell vehicles.

During cold starting or stop/start events, the battery system supplies current to a starter to crank the engine. When the vehicle is cold started, the battery needs to supply sufficient cranking power. In some applications, the battery system may continue to supply power for various electrical systems of the vehicle after the engine is started. An alternator or regeneration recharges the battery system.

### SUMMARY

A pouch-type battery module includes M parallel-connected battery cell cores each including anode electrodes, cathode electrodes, separators, cathode current collectors, and anode current collectors arranged in a stack and connected in parallel, where M is an integer greater than one. First and second external tabs are connected to the anode current collectors and the cathode current collectors, respectively, of the M parallel-connected battery cell cores. M-1 bipolar laminated films are arranged between adjacent ones of the M parallel-connected battery cell cores. First and second outer laminated films arranged adjacent to outer ones of the M parallel-connected battery cell cores and encapsulating the M parallel-connected battery cell cores with the first and second external tabs connected together and extending from opposite sides thereof.

In other features, the M parallel-connected battery cell cores are semi-solid-state and further comprising at least one of liquid electrolyte and a gel electrolyte. The M parallel-connected battery cell cores are all-solid-state. Pouch-type battery module includes liquid electrolyte.

In other features, the M-1 bipolar laminated films include a first cast polymer layer, a first adhesive layer, a first metal layer, a second metal layer, a second adhesive layer, and a second cast polymer layer.

In other features, the first cast polymer layer and the first adhesive layer and the second cast polymer layer and the second adhesive layer are arranged at edges of the first metal layer and the second metal layer to allow series connection of the adjacent ones of the M parallel-connected battery cell cores. The first metal layer and the second metal layer are made of a material selected from a group consisting of aluminum, copper, stainless steel, nickel, titanium, nickel-copper clad, aluminum-nickel clad, aluminum nickel clad, aluminum-stainless steel clad, and nickel-stainless steel clad. The first cast polymer layer and the second cast polymer layer are made of a material selected from a group consisting of polypropylene (PP), polyethylene (PE), and a polyolefin layer.

In other features, the first metal layer and the second metal layer have a thickness in a range from 2 to 50 μm. The first cast polymer layer and the second cast polymer layer have a thickness in a range from 1 to 50 μm, and the first adhesive layer and the second adhesive layer have a thickness in a range from 1 to 20 μm.

A pouch-type battery module includes M parallel-connected battery cell cores each including anode electrodes, cathode electrodes, separators, cathode current collectors, and anode current collectors arranged in a stack and connected in parallel, where M is an integer greater than one. First and second external tabs are connected to the anode current collectors and the cathode current collectors, respectively, of the M parallel-connected battery cell cores. M-1 first laminated films arranged adjacent to first sides of the M-1 of the M parallel-connected battery cell cores. M-1 second laminated films are arranged adjacent to second sides of the M-1 of the M parallel-connected battery cell cores. First and second outer laminated films arranged adjacent to outer ones of the M parallel-connected battery cell cores and encapsulating the M parallel-connected battery cell cores with the first and second external tabs connected together and extending from opposite sides thereof.

In other features, the M parallel-connected battery cell cores are semi-solid-state and further comprising at least one of liquid electrolyte and a gel electrolyte. The M parallel-connected battery cell cores are all-solid-state. The pouch-type battery module includes liquid electrolyte.

In other features, the M-1 first laminated films include a first cast polymer layer, a first adhesive layer, and a first metal layer. The M-1 second laminated films include a second metal layer, a second adhesive layer, and a second cast polymer layer.

In other features, the first cast polymer layer and the second cast polymer layer are arranged at edges of the first metal layer and the second metal layer. The first metal layer and the second metal layer are made of a material selected from a group consisting of aluminum, copper, stainless steel, nickel, titanium, nickel-copper clad, aluminum-nickel clad, aluminum nickel clad, aluminum-stainless steel clad, and nickel-stainless steel clad. The first cast polymer layer and the second cast polymer layer are made of a material selected from a group consisting of polypropylene (PP), polyethylene (PE), and a polyolefin layer.

In other features, the first cast polymer layer and the second cast polymer layer have a thickness in a range from 1 to 50 μm. The first adhesive layer and the second adhesive layer have a thickness in a range from 1 to 20 μm. The first metal layer and the second metal layer have a thickness in a range from 2 to 50 μm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a battery according to the present disclosure;

FIG. 2 is a side cross section of an example of a parallel-connected battery cell core;

FIG. 3 a side cross section of an example of an enclosure for a plurality of the parallel-connected battery cell cores with bipolar plates arranged therebetween;

FIG. 4 is a side cross section of an example of a parallel-connected battery cell core for a pouch cell according to the present disclosure;

FIG. 5 is an exploded view of an example of the pouch cell according to the present disclosure;

FIG. 6 is a side cross section of an example of the pouch cell according to the present disclosure;

FIG. 7 is a side view and cross section of an example of a battery cell core and a bipolar laminated film, respectively, according to the present disclosure;

FIG. 8 is a side cross section of an example of an outer laminated film;

FIGS. 9 and 10 are flowcharts of an example of methods for manufacturing the pouch battery cell according to the present disclosure;

FIG. 11 is an exploded view of another example of the pouch cell according to the present disclosure; and

FIG. 12 is a side view and cross section of an example of a battery cell core and first and second bipolar laminated films, respectively, according to the present disclosure.

In the drawings, reference numbers may be reused to identify similar and/or identical elements.

### DETAILED DESCRIPTION

While the battery systems are described herein in vehicle applications, the battery systems may be used in non-vehicle applications.

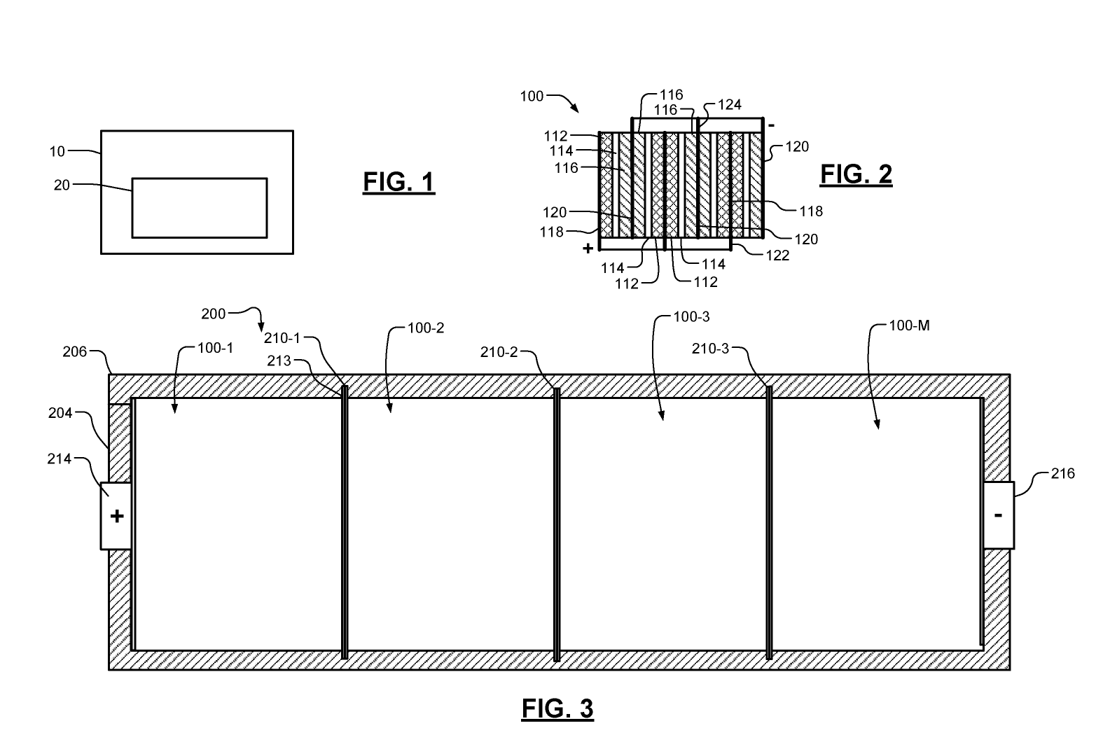

Referring now to FIG. 1, a vehicle 10 includes a battery 20 including one or more pouch-type bipolar solid-state battery modules. In some examples, the battery 20 may be used in low voltage automotive battery systems such as 12V battery systems used for starting vehicles, supporting stop/start functionality, and/or supplying vehicle accessory loads or other vehicle systems. In other examples, the battery 20 may be used for other purposes such as propulsion.

Referring now to FIG. 2, an example of a parallel-connected, bipolar solid-state battery cell core 100 is shown. In this example, the parallel-connected, bipolar solid-state battery cell core 100 includes cathode electrodes 112, separators 114, and anode electrodes 116 arranged in a stack as shown and connected in parallel. In the example in FIG. 2, the stack includes a cathode current collector 118, the cathode electrode 112, the separator 114, the anode electrode 116, an anode current collector 120, the anode electrode 116, the separator 114, and so on. External tabs 122 connected to the cathode current collectors 118 are connected to a positive terminal “+”. External tabs 124 connected to the anode current collectors 120 are connected to a negative terminal “-“.

Referring now to FIG. 3, M of the bipolar solid-state battery cell cores 100-1, 100-2, …, and 100-M are shown arranged in a battery enclosure 200 and connected in series, where M is an integer greater than one. In this example, M = 4. The battery enclosure 200 includes a lower portion 204 and a cover 206. In some examples, the lower portion of the battery enclosure 200 has a rectangular cross-section. The lower portion 204 includes a bottom surface, first and second side walls, and first and second end walls. Clad or bipolar plates 210-1, 210-2, and 210-3 are arranged between the first and second sidewalls (adjacent bipolar battery cells). Outermost ones of the adjacent bipolar battery cells are arranged between a positive terminal 214 and one of the clad plates and a negative terminal 216 and one of the clad plates, respectively.

In some examples, the clad plates 210-1, 210-2, and 210-3 are received in channels 213 formed on one or more inner surfaces of the lower portion 204 and the cover 206 of the battery enclosure 200. In this example, the bipolar battery cell 110-1 is arranged between the positive terminal 214 and the clad plate 210-1. The bipolar battery cell 110-2 is arranged between the clad plate 210-1 and the clad plate 210-2. The bipolar battery cell 110-3 is arranged between the clad plate 210-2 and the clad plate 210-3. The bipolar battery cell 110-4 is arranged between the clad plate 210-3 and the negative terminal 216.

Battery cells are typically compressed during manufacturing. With the use of the rigid enclosure in FIG. 3, insufficient pressure is generated across the battery cells. The low compression reduces cold-cranking capability.

Referring now to FIG. 4, one of the M parallel-connected battery cell cores 226 for a pouch-type cell is shown. One of the M parallel-connected battery cell cores 226 includes cathode electrodes 112, separators 114, and anode electrodes 116 arranged in a stack and connected in parallel. In the example in FIG. 4, the stack includes the cathode current collector 118, the cathode electrode 112, the separator 114, the anode electrode 116, the anode current collector 120, the anode electrode 116, the separator 114, and so on. The external tabs 122 connected to the cathode current collectors 118 are connected to the positive terminal “+”. The external tabs 124 connected to the anode current collectors 120 are connected to the negative terminal “-”.

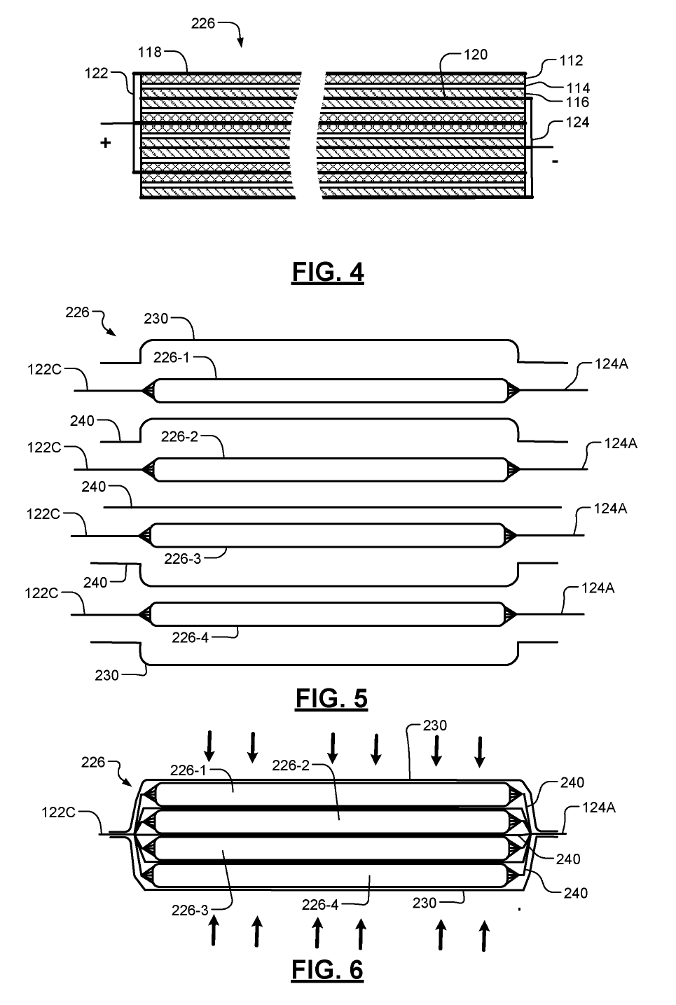

Referring now to FIG. 5, an exploded view of an example of the pouch-type battery module is shown. M parallel-connected battery cell cores 226-1, 226-2, …, and 226-M are provided (e.g., M=4 in this example). Outer laminated film 230 is arranged adjacent to outermost ones of the M parallel-connected battery cell cores 226-1, 226-2, …, and 226-M. Bipolar laminated film 240 is arranged between adjacent ones of the M parallel-connected battery cell cores 226-1, 226-2, …, and 226-M.

Referring now to FIG. 6, the pouch-type battery module is shown after assembly. Outer laminated film 230 encapsulates the M parallel-connected battery cell cores 226-1, 226-2, …, and 226-M with external tabs 122Cand 124Aof the M parallel-connected battery cell cores 226-1, 226-2, …, and 226-M extending from opposite ends for connection purposes. The flexible enclosure allows sufficient pressure to be generated across the battery cells. The higher compression enables cold-cranking capability.

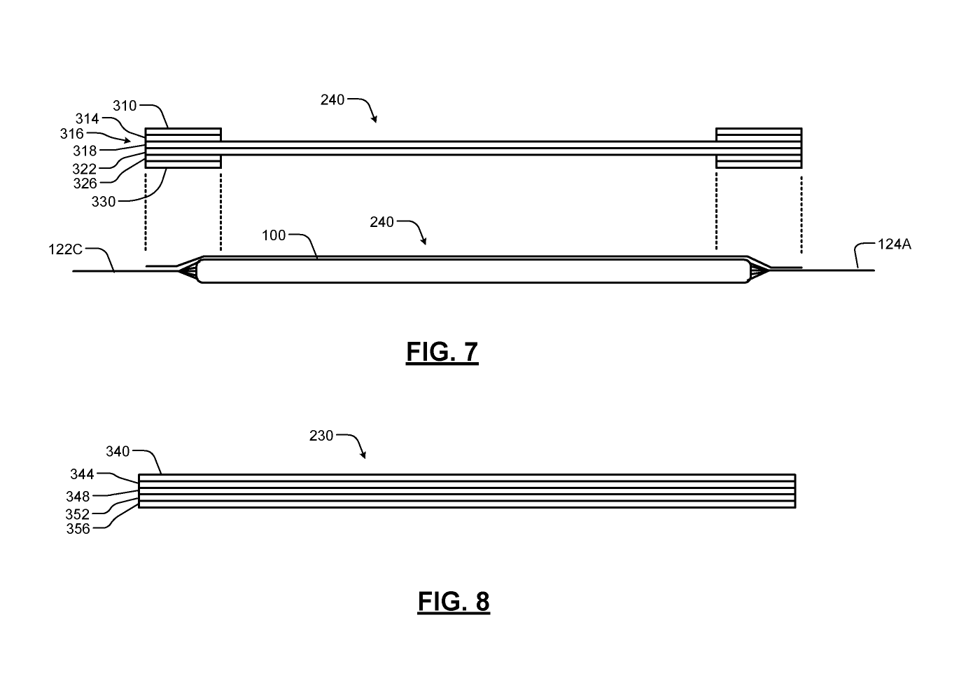

Referring now to FIG. 7, one of the M parallel-connected battery cell cores 226 and one of the bipolar laminated film 240 are shown. The bipolar laminate film 240 includes a cast polymer layer 310, an adhesive layer 314, a bipolar metal layer 316 (including a first metal layer 318 and a second metal layer 322), an adhesive layer 326, and a cast polymer layer 330. The cast polymer layers 310 and 330 coat edges of the bipolar laminate film 240. Portions of the metal layers between the edges allow series connection of the adjacent ones of the M parallel-connected battery cell cores. The cast polymer layers 310 and 330 tightly seal each cell core after applying hot pressing and prevent leaking of electrolyte into adjacent cell cores.

In some examples, the first metal layer 318 is made of aluminum and the second metal layer 322 is made of copper. In some examples, the metal layers are made of foil or clad foil. In other examples, the first metal layer 318 and the second metal layer 322 are made of a material selected from a group consisting of stainless steel, nickel, titanium, nickel-copper clad, aluminum-nickel clad, aluminum-stainless steel clad, nickel-stainless steel clad, and/or other metals or alloys. In some examples, the cast polymer layers 310 and 330 are made of a material selected from a group consisting of polypropylene (PP), polyethylene (PE), or other polyolefin layer.

In some examples, the cast polymer layers 310 and 330 have a thickness in a range from 1 to 50 μm. In some examples, the adhesive layers 314 and 326 have a thickness in a range from 1 to 20 μm. In some examples, the first metal layer 318 and the second metal layer 322 of the bipolar metal layer 316 have a thickness in a range from 2 to 50 μm.

Referring now to FIG. 8, an example of the outer laminated film 230 is shown. The outer laminated film 230 includes an outer layer 340, an adhesive layer 344, a metal layer 348, an adhesive layer 352, and a cast polymer layer 356. In some examples, the outer layer 340 is selected from a group consisting of nylon, PE, and oriented nylon film. In some examples, the outer layer 340 has a thickness in a range from 1 to 80 μm. In some examples, the metal layer 348 is selected from a group consisting of aluminum, stainless steel, and titanium. In some examples, the metal layer 348 has a thickness in a range from 2 to 60 μm. In some examples, the cast polymer layer 356 is made of a material selected from a group consisting of polypropylene (PP), polyethylene (PE), or other polyolefin layer. In some examples, the adhesive layers 344 and 352 include polyester-polyurethane and have a thickness in a range from 1 to 10 μm.

The bipolar metal layers enable series connection of the battery cell cores. The cast polymer layers are coated onto edges of the bipolar metal layers to prevent leaking of electrolyte into adjacent cell cores and ionic short circuits. The outer laminated layers encapsulate the components into a pouch and prevent unwanted electrolyte leakage or gas exchange. During operation, the battery cell core can be compressed as shown in FIG. 6 with high compressive pressure to enhance the performance of the pouch-type battery module.

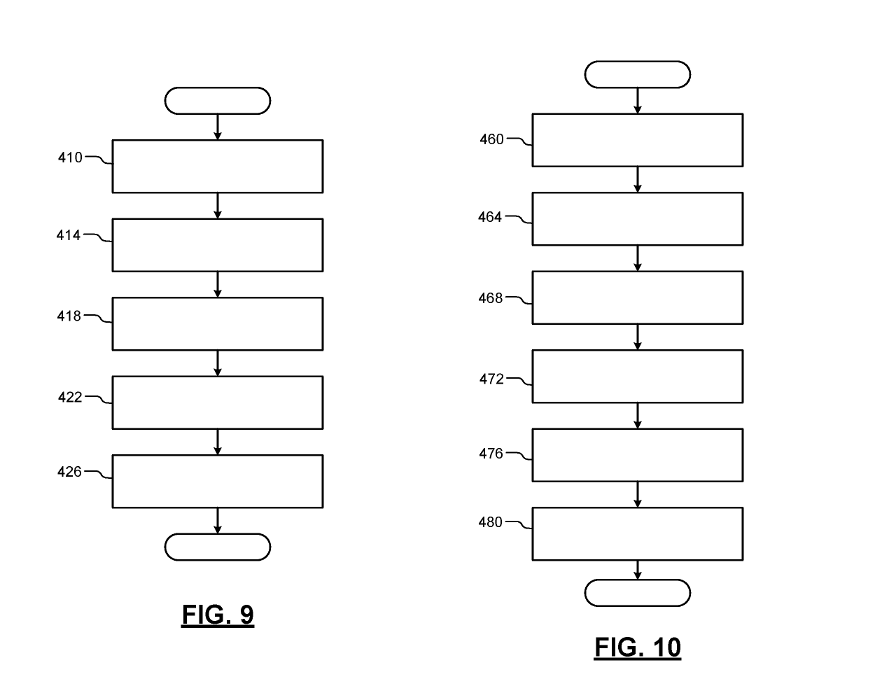

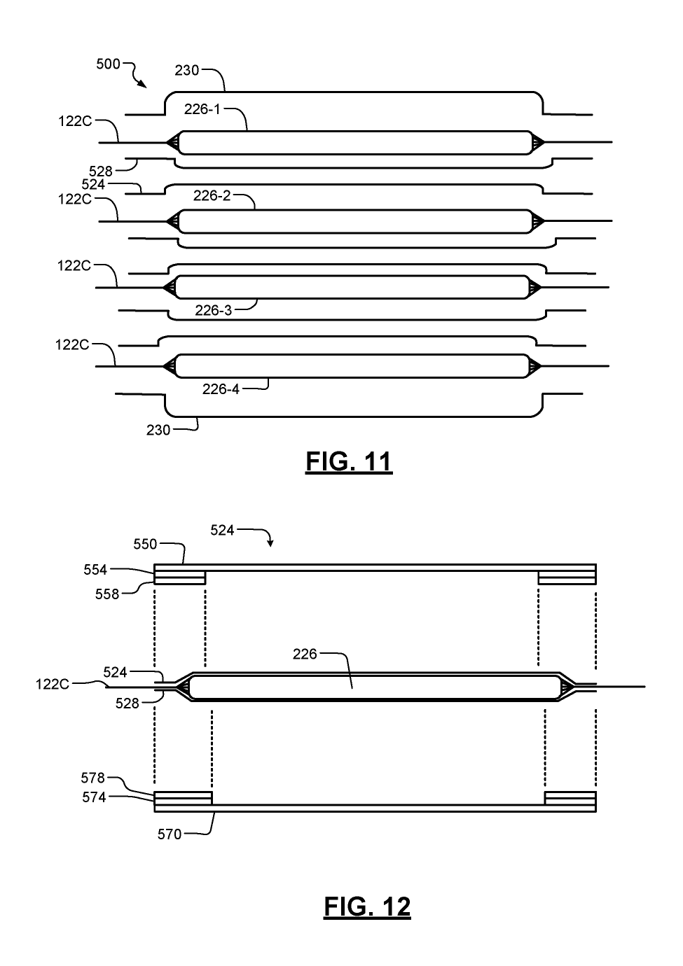

Referring now to FIGS. 9 and 10, examples of methods for manufacturing the pouch-type battery module are shown. In FIG. 9, the M parallel-connected battery cell cores are manufactured at 410. At 414, anode and cathode tabs of the M parallel-connected battery cell cores are welded. At 418, a liquid or gel precursor is optionally injected (and the gel is allowed to solidify) for liquid or semi-solid-state applications. At 422, the M parallel-connected battery cell cores, the bipolar laminated films, and the outer laminated films are stacked. At 426 edges of the pouch-type battery module are sealed.

In FIG. 10, the M parallel-connected battery cell cores are manufactured at 460. At 464, anode and cathode tabs of the M parallel-connected battery cell cores are welded. At 468, the M parallel-connected battery cell cores, the bipolar laminated films, and the outer laminated films are stacked. At 472, three of the four edges of the pouch-type battery module are sealed. At 476, a liquid or gel precursor is optionally injected (and the gel is allowed to solidify) for liquid or semi-solid-state applications. At 480, the remaining edge of the pouch-type battery module is sealed.

Referring now to FIG. 11, an exploded view of an example of the pouch-type battery module 500 is shown. M parallel-connected battery cell cores 226-1, 226-2, …, and 226-M are provided. Outer laminated film 230 is arranged adjacent to outermost ones of the M parallel-connected battery cell cores 226-1, 226-2, …, and 226-M. A first laminated film 524 and a second laminated film 528 are arranged between adjacent ones of the M parallel-connected battery cell cores 226-1, 226-2, …, and 226-M.

Referring now to FIG. 12, the first laminated film 524 and the second laminated film 528 are shown. The first laminated film 524 includes an aluminum layer 550, an adhesive layer, and a cast polymer layer 558. The second laminated film 528 includes a copper layer 570, an adhesive layer 574, and a cast polymer layer 578. The cast polymer layers 558 and 578 are located at edges of the M parallel-connected battery cell cores 226.

The pouch-type battery modules can include included standard cell cores with liquid electrolyte, semi-solid-state cell cores with solid electrolyte and gel or liquid electrolyte, or all-solid state cores with solid electrolyte.

In some examples, the number of cell cores can be 4 for a 12V module. However, addition or fewer cell cores can be used for other cell voltages from 6V to 48V or other voltage up to 400V.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A pouch-type battery module comprising:
M parallel-connected battery cell cores each including anode electrodes, cathode electrodes, separators, cathode current collectors, and anode current collectors arranged in a stack and connected in parallel, where M is an integer greater than one;
first and second external tabs connected to the anode current collectors and the cathode current collectors, respectively, of the M parallel-connected battery cell cores;
M-1 bipolar laminated films arranged between adjacent ones of the M parallel-connected battery cell cores; and
first and second outer laminated films arranged adjacent to outer ones of the M parallel-connected battery cell cores and encapsulating the M parallel-connected battery cell cores with the first and second external tabs connected together and extending from opposite sides thereof.

2. The pouch-type battery module of claim 1, wherein the M parallel-connected battery cell cores are semi-solid-state and further comprising at least one of liquid electrolyte and a gel electrolyte.

3. The pouch-type battery module of claim 1, wherein the M parallel-connected battery cell cores are all-solid-state.

4. The pouch-type battery module of claim 1, further comprising liquid electrolyte.

5. The pouch-type battery module of claim 1, wherein the M-1 bipolar laminated films include:
a first cast polymer layer;
a first adhesive layer;
a first metal layer;
a second metal layer;
a second adhesive layer; and
a second cast polymer layer.

6. The pouch-type battery module of claim 5, wherein the first cast polymer layer and the first adhesive layer and the second cast polymer layer and the second adhesive layer are arranged at edges of the first metal layer and the second metal layer to allow series connection of the adjacent ones of the M parallel-connected battery cell cores.

7. The pouch-type battery module of claim 5, wherein the first metal layer and the second metal layer are made of a material selected from a group consisting of aluminum, copper, stainless steel, nickel, titanium, nickel-copper clad, aluminum-nickel clad, aluminum nickel clad, aluminum-stainless steel clad, and nickel-stainless steel clad.

8. The pouch-type battery module of claim 5, wherein the first cast polymer layer and the second cast polymer layer are made of a material selected from a group consisting of polypropylene (PP), polyethylene (PE), and a polyolefin layer.

9. The pouch-type battery module of claim 5, wherein the first metal layer and the second metal layer have a thickness in a range from 2 to 50 μm.

10. The pouch-type battery module of claim 5, wherein:
the first cast polymer layer and the second cast polymer layer have a thickness in a range from 1 to 50 μm; and
the first adhesive layer and the second adhesive layer have a thickness in a range from 1 to 20 μm.

11. A pouch-type battery module comprising:
M parallel-connected battery cell cores each including anode electrodes, cathode electrodes, separators, cathode current collectors, and anode current collectors arranged in a stack and connected in parallel, where M is an integer greater than one;
first and second external tabs connected to the anode current collectors and the cathode current collectors, respectively, of the M parallel-connected battery cell cores;
M-1 first laminated films arranged adjacent to first sides of the M-1 of the M parallel-connected battery cell cores;
M-1 second laminated films arranged adjacent to second sides of the M-1 of the M parallel-connected battery cell cores; and
first and second outer laminated films arranged adjacent to outer ones of the M parallel-connected battery cell cores and encapsulating the M parallel-connected battery cell cores with the first and second external tabs connected together and extending from opposite sides thereof.

12. The pouch-type battery module of claim 11, wherein the M parallel-connected battery cell cores are semi-solid-state and further comprising at least one of liquid electrolyte and a gel electrolyte.

13. The pouch-type battery module of claim 11, wherein the M parallel-connected battery cell cores are all-solid-state.

14. The pouch-type battery module of claim 11, further comprising liquid electrolyte.

15. The pouch-type battery module of claim 11, wherein the M-1 first laminated films include:
a first cast polymer layer;
a first adhesive layer; and
a first metal layer.

16. The pouch-type battery module of claim 15, wherein the M-1 second laminated films include:
a second metal layer;
a second adhesive layer; and
a second cast polymer layer.

17. The pouch-type battery module of claim 16, wherein the first cast polymer layer and the second cast polymer layer are arranged at edges of the first metal layer and the second metal layer.

18. The pouch-type battery module of claim 16, wherein the first metal layer and the second metal layer are made of a material selected from a group consisting of aluminum, copper, stainless steel, nickel, titanium, nickel-copper clad, aluminum-nickel clad, aluminum nickel clad, aluminum-stainless steel clad, and nickel-stainless steel clad.

19. The pouch-type battery module of claim 16, wherein the first cast polymer layer and the second cast polymer layer are made of a material selected from a group consisting of polypropylene (PP), polyethylene (PE), and a polyolefin layer.

20. The pouch-type battery module of claim 16, wherein:
the first cast polymer layer and the second cast polymer layer have a thickness in a range from 1 to 50 μm;
the first adhesive layer and the second adhesive layer have a thickness in a range from 1 to 20 μm; and
the first metal layer and the second metal layer have a thickness in a range from 2 to 50 μm.
